(19) United States
(12) Patent Application Publication
(10) Pub. No.: US 2013/0245251 A1
(43) Pub. Date: Sep. 19, 2013

(54) METHOD FOR ISOLATING DIETARY FIBER ARABINOGALACTAN AND ARABINOGALACTAN IN COMBINATION WITH FLAVONOID DIHYDROQUERCETIN (TAXIFOLIN) FROM CONIFER WOOD SPECIES OR HARDWOOD INCLUDING BUTT LOGS AND BARK

(71) Applicants: Sergey V. Philippov, Moscow (RU); Igor M. Bogorodov, Moscow (RU)

(72) Inventors: Sergey V. Philippov, Moscow (RU); Igor M. Bogorodov, Moscow (RU)

(73) Assignee: FLAVITPURE, INC., Cheyenne, WY (US)

(21) Appl. No.: 13/423,198

(22) Filed: Mar. 17, 2012

(51) Int. Cl. C08B 37/14

(52) U.S. Cl. 536/123

(57) ABSTRACT

A method for isolating arabinogalactan and arabinogalactan with flavonoid dihydroquercetin (taxifolin) from wood, including butt logs and bark. The method includes extracting an extract from a combination of a polar solvent with wood particles and recovering the extract. The wood particles include at least one of i) a particle-reduced chip fraction obtained by subdividing the butt logs into chips, and ii) a dry cork fraction of the bark or a powdered bark obtained as a residue in finishing of mechanical wood products. The wood is a coniferous hardwood or a coniferous wood selected from the group consisting of a wood of a Larix genus, a spruce wood of a genus Picea, a fir wood of a genus Abies, a pine wood of a genus Pinus, or a wood of a Pseudotsuga genus.

### REFERENCES

[1] Tatjana Stevanovic, Papa Niokhor Diouf and Martha Estrella Garcia-Perez. (2009) Bioactive Polyphenols from Healthy Diets and Forest Biomass. Current Nutrition & Food Science, Vol. 5. No. 4, p. 264-295.
[1a] Chun Ho-Ming. (2002). Conditioning shampoo containing arabinogalactan//U.S. Pat. No. 6,406,686 US. 2002. CA. V. 137:10711.
[1b] Westman M. 1999. Galactoarabinan: An Exfoliant for Human Skin, Cosmetics and Toiletries 1148, 63-72.
[2] Hillis W E (1971) Distribution, properties and formation of some wood extractives. Wood Science and Technology 5: 272-289.
[3] Cote W A, Day A C, Simson B W, Timell T E (1966) Studies on larch arabinogalactan 1. The distribution of arabionogalactan in larch wood. Holzforschung 20: 178-192.
[4] S. Willfor, R. Sjoholm, C. Laine, B. Holmbom. (2002) Structural features of water-soluble arabinogalactans from Norway spruce and Scots pine heartwood. Wood Science and Technology, 36: 101-110.
[5] Lewin M. & Goldstein I. S. (1991): Wood structure and composition. Marcel Dekker, Inc. International fiber science and technology series: vol. 11. ISBN: 0-8247-8233-x
[6] Giwa S. A. O. & Swan E. P. (1975). Heartwood extractives of a western larch tree (Larix occidentalis Nutt.). Wood and Fiber vol. 7(3), pp. 216-221.
[7] Terziev, N. (2002b): Properties and Processing of Larch Timber—a Review based on Soviet and Russian Literature.
[8] Vince, A J. McNeil, N I. Wager, J D. Wrong, O M. (1990). The effect of lactulose, pectin, arabinogalactan, and cellulose on the production of organic acids and metabolism of ammonia by intestinal bacteria in a faecal incubation system. Br J Nutr 63:17-26.
[9] Salyers, A. A. Arthur. R. Kuritza, A. (1981). Digestion of larch arabinogalactan by a stain of human colonic Bacteroides growing in continuous culture. J Agric Food Chem 29:475-480.
[10] Lee S B, Cha K H, Selenge D, Solongo A, Nho C W (2007). The chemopreventive effect of taxifolin is exerted through ARE-dependent gene regulation. Biol Pharm Bull., 30(6): 1074-1079.
[11] Gupta M B, Bhalla T N, Gupta G P, Mitra C R, Bhargava K P. (1971). Anti-inflammatory activity of taxifolin. Japan J Pharmacol., 21(3):377-82.
[12] Ponder G R, Richards G N (1997a) Arabinogalactan from Western larch, Part II; a reversible order-disorder transition. J Carbohydr Chem 16:195-211.
[13] Kara'csonyi S, Kova'cik V, Alfo′ldi J, Kubackova' M (1984) Chemical and ¹³C-N.M.R. studies of an arabinogalactan from Larix sibirica L. Carbohydr Res 134:265-274.
[14] Simionescu C, Sang II B, Cematescu-Asandei A (1976) Researches in the field of chemistry and technology of larch wood pulping by magnesium bisulphite process. II. Structure of arabinogalactan from larch wood (Larix decidua Mill). Cellulose Chem. Technol., 10:535-545.
[15] Odonmazig, P. Ebringerova. A. Machova, E. Alföldi. J. (1994) Structural and molecular properties of arabinogalactan isolated from Mongolian larchwood (Larix dahurica L.). Carbohydr. Res. 252: 317-324.
[16] E. E. Nifant'ev, M. P. Koroteev, G. Z. Kaziev, A. A. Uminskii, A. A. Grachev, V. M. Men'shov, Yu.E. Tsvetkov, N. E. Nifant'ev, V. K. Bel'skii, A. I. Stash. (2006). On the Problem of Identification of the Dihydroquercetin Flavonoid. ISSN 1070-3632, Russian Journal of General Chemistry, 2006, Vol. 76, No. 1, pp. 161-163. Pleiades Publishing. Inc., 2006. Original Russian Text published in Zhurnal Obshchei Khimii, 2006, Vol. 76, No. 1. pp. 164-166.
[17] Antonova, G. F. 1980. Za\dot{p}asi, sostav i svojstva drevesini listvennitzej. In “Issledovaniya v oblasti drevesiny i drevesnykh materialov”. Institut lesa i drevesiny, Krasnoyarsk, 6-18.
[18] Aleksandrova, G. P., S. A. Medvedeva, Y. A. Malkov, D. V. Babkin and V. A. Babkin. 1998. Highly pure arabinogalactane—the product of complex larch wood processing. World Resources for Breeding, Resistance and Utilisation. IUFRO Interdivisional Symposium, Krasnoyarsk, Russia.
[19] Babkin V A, Ostroukhova L A, Malkov Y A, Babkin D V, Onuchina N A, Ivanova S Z (2001) Isolation of biologically active compounds from larch wood. 11th ISWPC, International Symposium on Wood and Pulping Chemistry, Nice. France. Vol. II, pp 119-122.
[20] Giwa S A O, Swan E P (1975) Heartwood extractives of a western larch tree (Larix occidentalis nutt.). Wood and Fiber 7: 216-221.
[21] Andreas Bergstedt and Christian Lyck (eds.). Larch wood—a literature review. Forest & Landscape Working Papers no. 23-2007. Forest & Landscape Denmark.
[22] Schimleck L R, Wright P J, Michell A J, Wallis A F A (1997) NIR Infrared spectra and chemical compositions of E. globulus and E. nitens wood. Appita 50: 40-50.
[23] Hegnauer. R. 1962. Chemotaxonomie der Pflanzen. 1st ed. Birkhäuser Verlag, Basel und Stuttgart, p. 381.
[24] Gierlinger, N., Schwanninger, M., Hinterstoisser, B., Wimmer, R. (2002) Rapid determination of heartwood extractives in Larix sp. by means of Fourier transform near infrared spectroscopy. J. Near Infrared Spectrosc. 10: 203-214.
[25] Saura-Calixto, F. Antioxidant dietary fiber product: A new concept and a potential food ingredient. J. Agric. Food Chem. 1998, 46, 4303-4306.

### FIELD OF THE INVENTION

This invention relates to a method for isolating wood extractives, i.e. soluble dietary fiber arabinogalactan and arabinogalactan in combination with flavonoid Dihydroquercetin (taxifolin), from conifer wood species or hardwood including butt logs and bark.

### BACKGROUND OF THE INVENTION

It is clear from all currently available sources, that the forest biomass in general and residues of wood transformation, in particular, represent important natural resources of dietary ingredients. These residues have a real potential to be used as raw materials for the development of food supplements and/or functional foods which can enhance the animal and human health by disease prevention [1]. They are also applicable, to cosmetics and pharmaceutical products development [1a,1b]. The emphasis is put on residues of conifer wood transformation such as butt logs and bark as these materials represent particularly rich resources mainly because of the heavily branched polysaccharide arabinogalactan [2,3,4,5,6]. Higher arabinogalactan content often goes hand in hand with higher amount of flavonoid substances [7]. Non-starch polysaccharide arabinogalactan is a non-digestible soluble dietary fiber with prebiotic functions fermented at a slower rate than other polysaccharides because of its branched structure, with the outcome of fermentation is the production of SCFA's (short chain fatty acids), principally acetate, propionate and butyrate, gases (carbon dioxide, hydrogen and methane) and bacterial cell mass [8]. Non-absorbed polysaccharide arabinogalactan is actively fermented by intestinal microflora and is particularly effective at increasing beneficial anaerobes such as mostly Lactobacillus and Bifidobacteria [9]. Flavonoid Dihydroquercetin (taxifolin) is one of the most effective natural antioxidants and anti-inflammatory compounds [10,11].

Arabinogalactans are class of long, densely branched low and high-molecular polysaccharides MW: 3,000-120,000. The molecular structures of water-soluble arabinogalactans from different hardwood species have been intensively investigated. Arabinogalactans consist of a main chain of b-D-(1fi3)-galactopyranose units (b-D-(1fi3)-Galp) where most of the main-chain units carry a side chain on C-6 [fi3,6)-Galp-(1fi]. Almost half of these side chains are b-D-(1fi6)-Galp dimers, and about a quarter are single Galp units. See FIG. 1. The rest contain three or more units. Arabinose is present both in the pyranose (Arap) and furanose (Araf) forms, attached to the side chains as arabinobiosyl groups [b-L-Arap-(1fi3)-LAraf-(1fi] or as terminal a-L-Araf e.g. a single L-arabinofuranose unit or 3-O-((β-L-arabinopyranosyl)-α-L-arabinofuranosyl units [12,13,14,15].

Flavonid Dihydroquercetin (taxifolin) is the compound having molecule structure, as shown in FIG. 2, based on C6-C3-C6 skeleton consisting of two aromatic rings joined by a three carbon link with the absence of the C2-C3 double bond and have two chiral carbon atoms in position 2 and 3 [16]. The A ring of the flavonoid structure being acetate derived (3×C2) and the C and B rings originating from cinnamic acid derivatives (phenylpropanoid pathway). Consequently, the B-ring can be either in the (2S)a- or (2R)-configuration. The C-3 atom of dihydroflavonol Dihydroquercetin (taxifolin) bears both a hydrogen atom and a hydroxyl group, and is therefore an additional center of asymmetry. Thus, four stereoisomers are possible for each dihydrofiavonol structure, (2R,3R), (2R,3S), (2S,3R), and (2S,3S). All four configurations have been found in naturally occurring dihydroflavonols, but the (2R,3R)-configuration is by far the most common. With respect to FIG. 2, dihydroquercetin was studied by means of X-ray diffraction. The sample of dihydroquercetin for X-ray diffraction analysis was crystallized from deionized water. Crystals of Dihydroquercetin, C₁₅H₁₂O₇*2.5H₂O, monoclinic; at 25° C. a 23.612, b 5.206, c 25.495 \ddot{̂}; β 103.18O, V3046.3 \ddot{̂}³, d_{calc} 1,520 g cm⁻³, Z 8, space group C2. It follows from the X-ray diffraction data that the heteroring in Dihydroquercetin molecule is an asymmetric half-chair with a planar system of the O¹, C⁹, C⁴ and C³ atoms. The B ring is turned with respect to the heteroring by 68.0°. The protons at the C² and C³ atoms are in the trans position, and the H²C²C³H³ dihedral angle is 178°.

Hardwood extractives are located mostly in rays [2], but may also form coatings on cell walls and pits, and penetrate cell walls. For example, in Larix species large amounts (up to 30%) of arabinogalcatan, a heavily branched polysaccharide based on arabinose and galactose are found in the cell lumens [3]. Also had been studied the organic soluble extractives from the heartwood of larch. The dominant flavonoids found are quercetin (11% of the total amount flavonoids), Dihydroquercetin (taxifolin) (69%) and dihydrokaempferol [17]. In Table 1 the higher arabinogalactan content often goes hand in hand with higher amount of flavonoid substances such as antioxidant Dihydroquercetin (taxifolin) [18,19,20].

From the early 1990s several parameters related to wood chemistry, i.e. pulp yield, cellulose and lignin content as well as wood extractives [22] have been estimated by Fourier transform near infrared (FT-NIR) spectroscopy. Furthermore, studies have shown that FT-NIR spectroscopy was also capable to determine physico-mechanical properties, including basic density, mechanical strength and stiffness. It may be concluded therefore, that since all factors influencing natural durability, i.e. hardwood extractives, lignin and density, may be successfully determined by FT-NIR spectroscopy, it may also have the potential to rapidly and non-destructively predict natural durability. FT-NIR spectroscopy has proven to be a reliable, accurate and rapid method for the determination of hardwood extractives as well as of lignin content and of natural durability. High numbers of samples can be non-destructively measured. Two distinctive minima between 7100 cm-1 and 6900 cm-1 and between 5300 and 5150 cm-1 were found in the spectra of wood powder, solid wood and all extracts. The hot-water extract and pure arabinogalactan spectra are similar, although in the latter the minima at 6465 cm-1 and around 5900 cm-1 are clearer. Dihydroquercetin (taxifolin) and water-ethanol extract spectra show a distinct minimum at 6044 cm-1, also apparent in the wood samples. The pure dihydroquercetin (taxifolin) has additional minima and maxima at 8871 cm-1 , 6994 cm-1 and 6763 cm-1 and some smaller ones below 6000 cm-1 [24]. The flavonoid Dihydroquercetin (taxifolin) (3,3′,4′,5,7-Pentahydroxyflavanone), which is known to be a major phenolic compound in larch hardwood [23], shows strong bands within the range from 6300 to 5300 cm-1 (1587- 1887 nm) [24].

After screening of a large number of vegetable by-products, were obtained numerous dietary fibers with exceptional biological antioxidant capacity from fruits and other vegetable materials. These fibers combine in a single material the physiological effects of both dietary fiber and antioxidants [25]. Dietary fiber arabinogalactan from hardwoods, mainly from Larix dahurica (Larix gmelinii), Larix sibirica, Larix sukaczewii larch wood species, i.e. larch arabinogalactan can be defined as a fiber containing significant amounts of natural antioxidants, mainly Dihydroquercetin (taxifolin) associated naturally to the fiber matrix with the following specific characteristics (see FIG. 4): 1. Dietary fiber content, higher than 70% dry matter basis. 2. One gram of dietary fiber larch arabinogalactan should have a capacity to inhibit lipid oxidation equivalent to, at least, 1,000 umol TE/gram basing on ORAC value and normally to 2,000-4,000 umol TE/gram 3. One gram of dietary fiber larch arabinogalactan should have a capacity of Cell-based Antioxidant Protection (CAP-e) to protect live cells from oxidative damage to, at least 6 CAP-e units per gram, where the CAP-e value is in Gallic Acid Equivalent (GAE) units. 4. The antioxidant capacity must be an intrinsic property, derived from natural constituents of the material (soluble in digestive fluids) not by added antioxidants or by previous chemical or enzymatic treatments.

### SUMMARY OF THE INVENTION

In one general aspect, the invention relates to the method of combining the isolation of soluble dietary prebiotic fiber arabonogalactan and arabinogalactan in combination with flavonoid Dihydroquercetin (taxifolin) from conifer wood species or hardwood including butt logs and bark. The object of this invention is thus to i) provide practically useful sources for the useful arabinogalactan substances and ii) improve the economy for the manufacturing processes of mechanical wood products in that by-products, which prior to the present invention were used only for energy production and other non-extraction purposes, are offered a new use as sources for soluble dietary prebiotic fiber arabinogalactan and arabinogalactan in combination with flavonoid Dihydroquercetin (taxifolin).

Thus, in its general aspect, the invention is a method for isolating arabinogalactan and arabinogalactan in combination with flavonoid Dihydroquercetin (taxifolin) from wood comprising lower portion of the trunks, referred to as the butt logs and bark. The method includes the steps of:

a) extracting

i) the particle-reduced chip fraction obtained by chipping subdividing into chips the butt logs, or

ii) dry cork fraction of the bark or powdered bark obtained as residue in finishing of mechanical wood products with a polar solvents, and

b) recovering the extract,
wherein the wood is coniferous wood selected from the group consisting of

wood of Larix genus;

spruce wood of the genus Picea;

fir wood of the genus Abies;

pine wood of the genus Pinus;

wood of Pseudotsuga genus

or the wood is hardwood.

The isolated prime substances from all mentioned genus are arabinogalactan and arabinogalactan in combination with Dihydroquercetin (taxifolin), where the content of the latter is not less than 5% up to 50%, preferably 5%-10%, 10%-15% and 15%-20%.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWINGS AND TABLES

The invention is illustrated by way of example and not limitation and the figures of the accompanying drawings in which like references denote like or corresponding parts, and in which:

FIG. 1 shows Arabinogalactan component units (source: hardwoods);

FIG. 2 shows steric structure of dihydroquerceiine molecule;

FIG. 3 shows Table 1 demonstrating an amount of extractives in the wood of Larix dahurica (Larix gmelinii) at various ages;

FIGS. 4-15 show HPLC chromatograms and tabulated data of larch arabinogalactan consisting with 5% of dihydroquercetin (taxifolin) and larch arabinogalactan consisting with 10% of dihydroquercetin (taxifolin), specifically:

FIG. 4 shows HPLC chromatogram from LAG5 at λ(UV) 288 nm;

FIG. 5 shows UV chromatogram of DHQ-peak at λ(UV) 288 nm;

FIG. 6 shows HPLC chromatogram from LAG5 at λ(UV) 254 nm;

FIG. 7 shows Table 2 demonstrating HPLC data of LAG5 at λ(UV) 340 nm;

FIG. 8 shows HPLC chromatogram from LAG5 at λ(UV) 340 nm;

FIG. 9 shows Table 3 demonstrating HPLC data of LAG5 at λ(UV) 340 nm;

FIG. 10 shows HPLC chromatogram from LAG10 at λ(UV) 288 nm;

FIG. 11 shows UV chromatogram of DHQ-peak at λ(UV) 288 nm;

FIG. 12 shows HPLC chromatogram from LAG10 at λ(UV) 254 nm;

FIG. 13 shows Table 4 demonstrating HPLC data of LAG10 at λ(UV) 254 nm;

FIG. 14 shows HPLC chromatogram from LAG10 at λ(UV) 340 nm;

FIG. 15 shows Table 5 demonstrating HPLC data of LAG 10 at λ(UV) 340 nm; and

FIG. 16 shows a schematic diagram of the system utilized in the process of isolation of arabinogalactan and arabinogalactan in combination with flavonoid Dihydroquercetin (taxifolin) from wood.

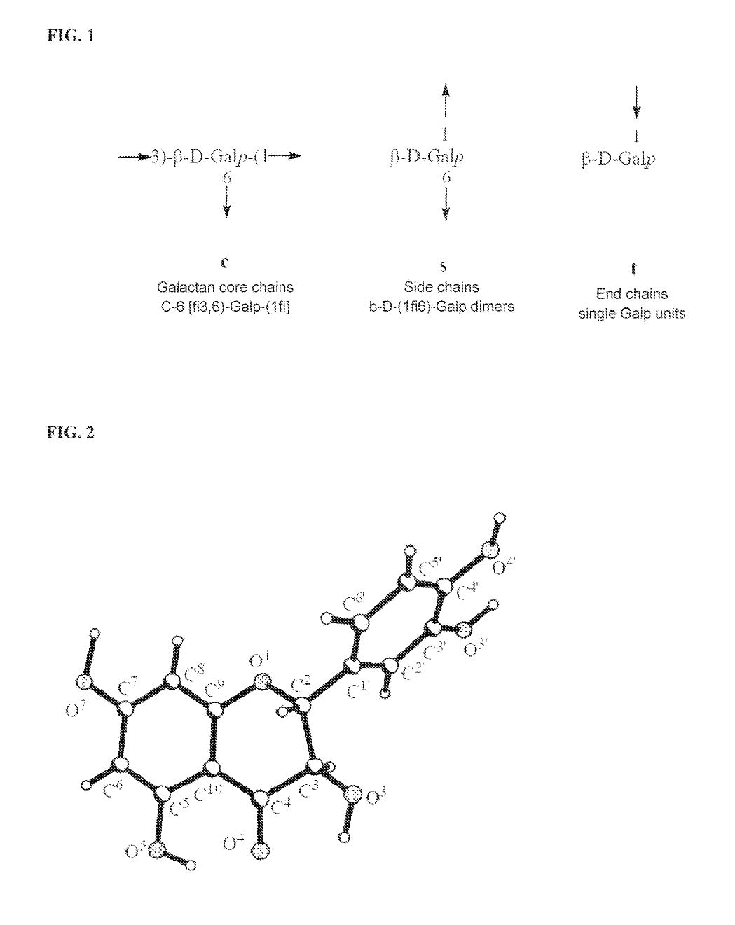

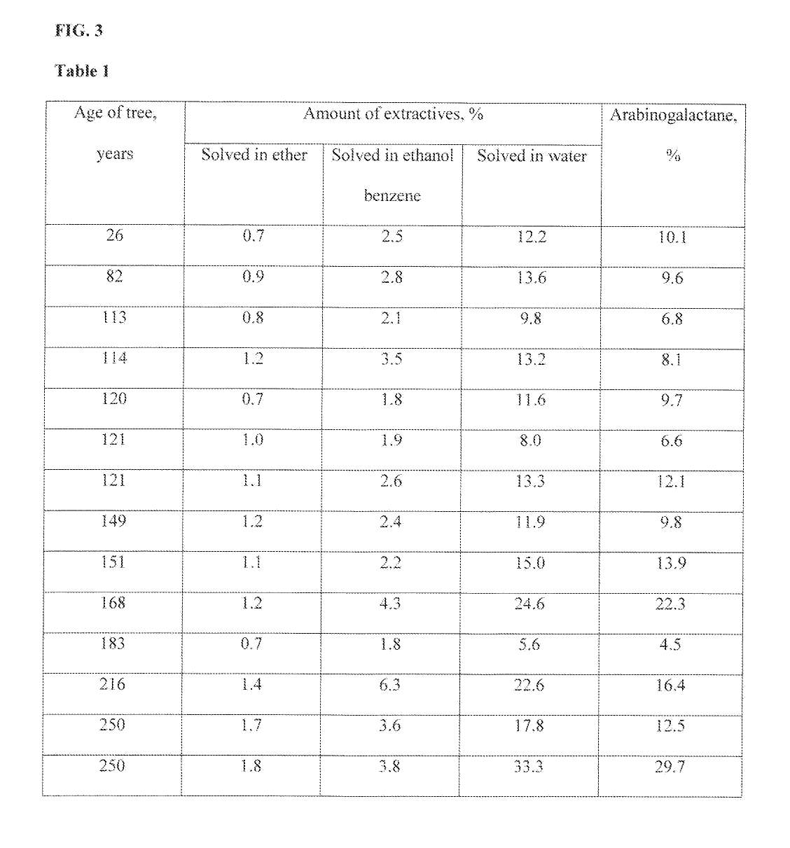

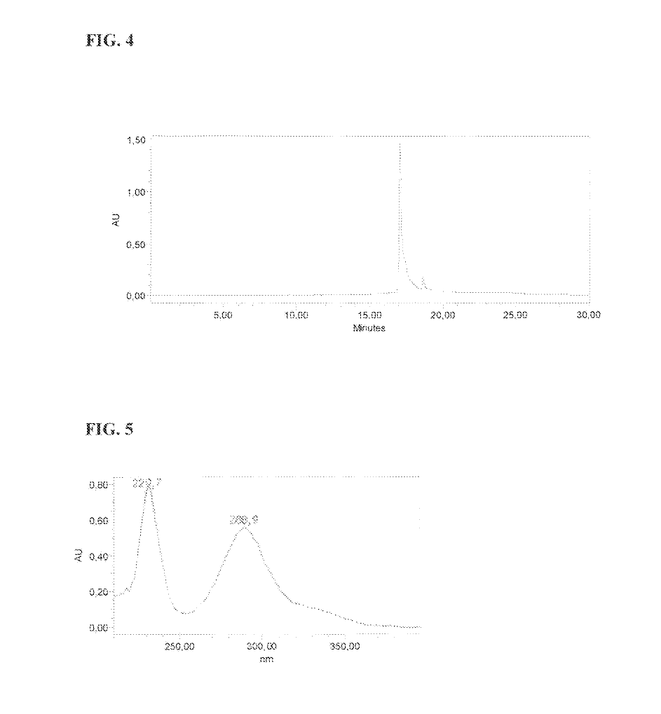

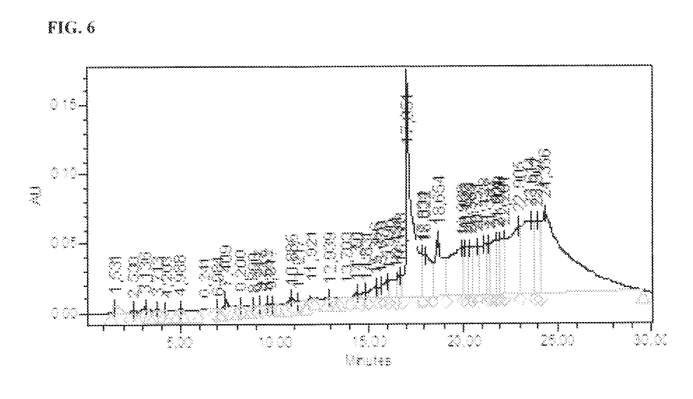

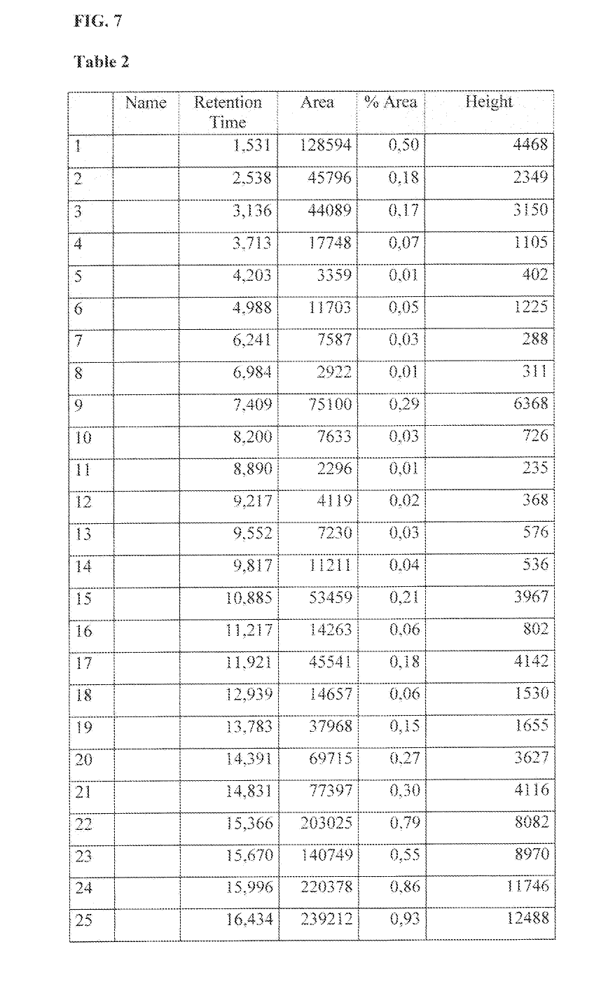

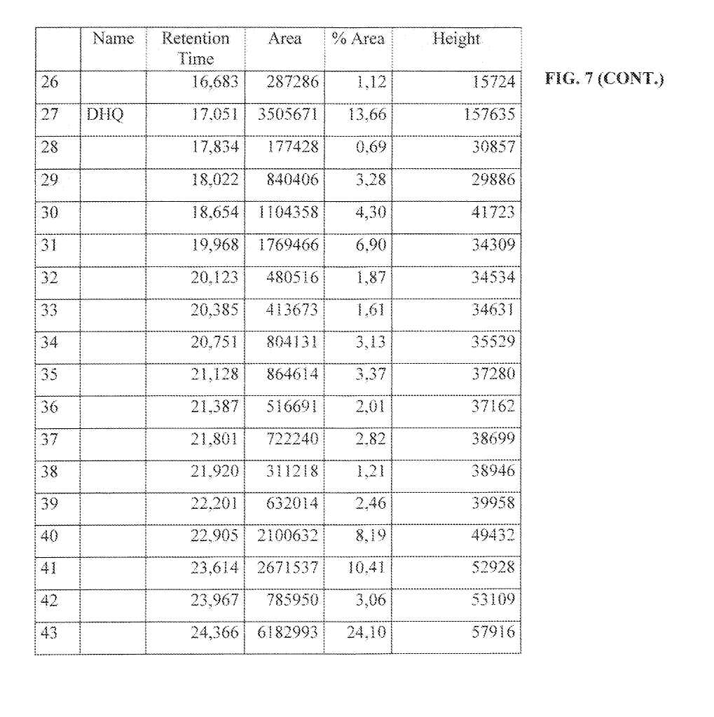

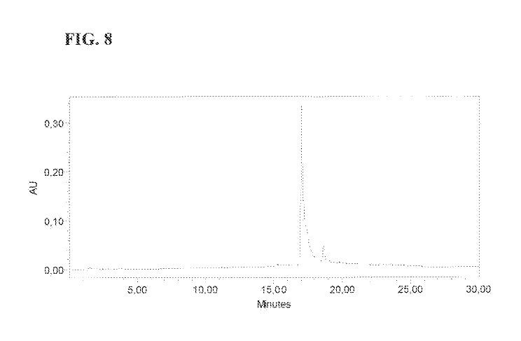

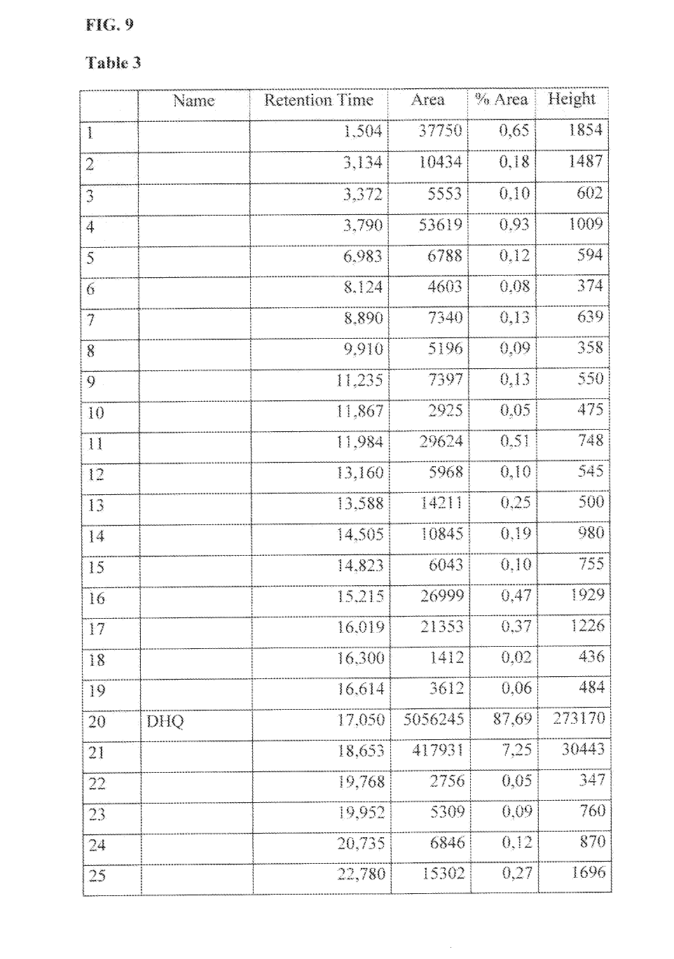

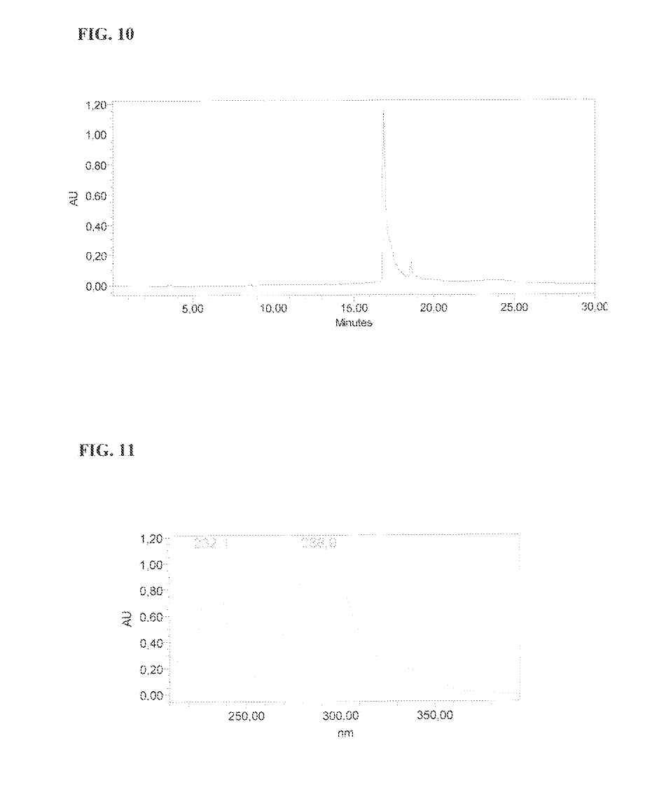

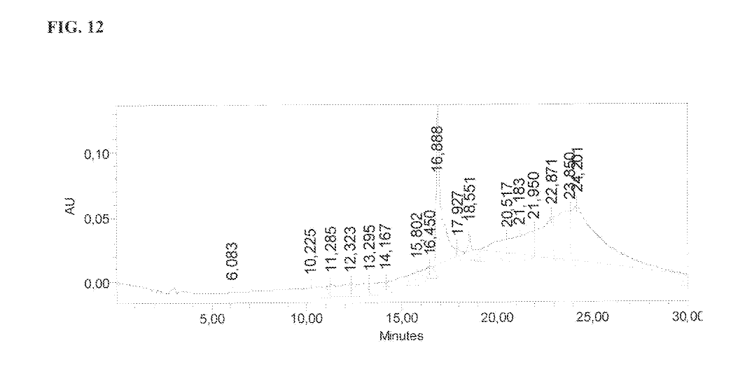

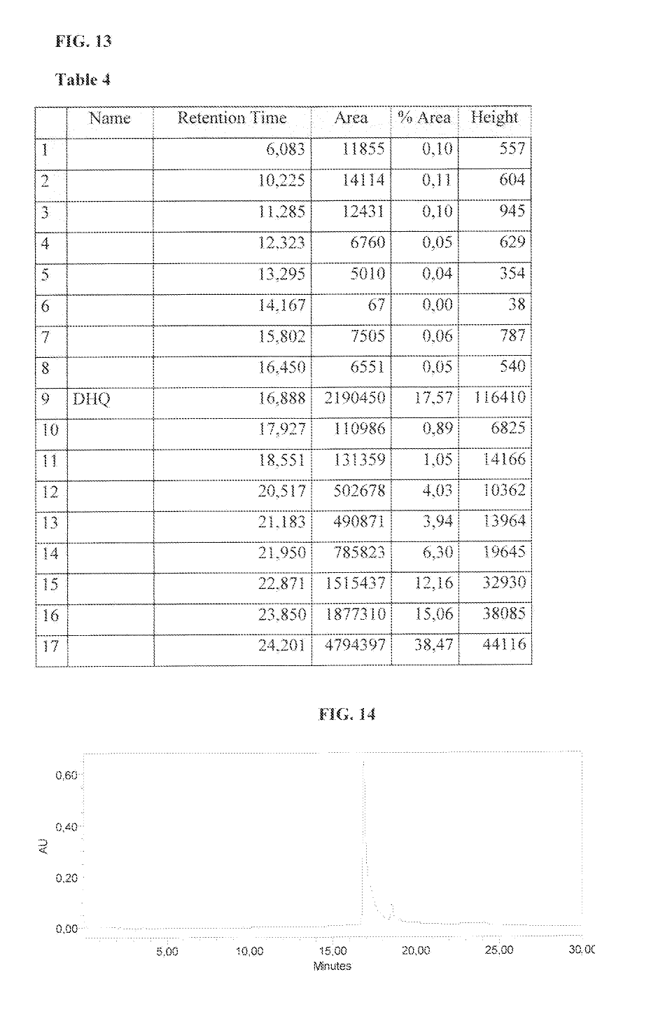

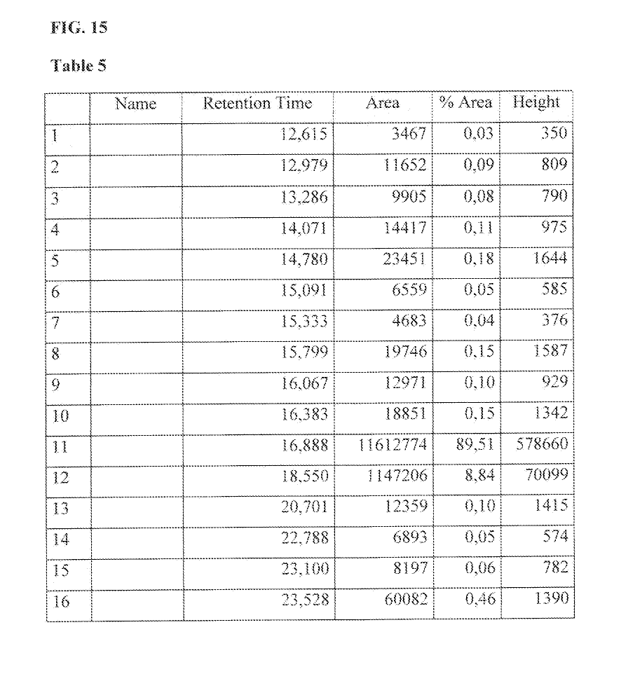

### DETAILED DESCRIPTION OF THE INVENTION

The term “polysaccharide” shall be understood to cover arabinogalactan, the class of long, densely branched low and high-molecular polysaccharides with molecular weight of 3,000-120,000 Daltons and arabinogalactan in combination with flavonoid Dihydroquercetin (taxifolin), where polysaccharide content is higher than 70% dry matter basis. The term “flavonoid” shall be understood to cover Dihydroquercetin (taxifolin), the class of dihydroflavonols is based on C6-C3-C6 skeleton consisting of two aromatic rings joined by a three carbon link with the absence of the C2-C3 double bond and have two chiral carbon atoms in position 2 and 3.

All of these groups are mainly hydrophilic substances that can be extracted with polar, i.e. hydrophilic solvents.

The term “butt logs” shall be understood to include the lower part of a tree trunk that extends to maximum of 1 meter height from soil surface.

The term “bark” shall be understood to include the “tissues outside of the vascular cambium,” i.e. the outermost layers of stems and roots of woody plants.

The “particle reduced chip fraction” means the rejected fraction obtained by sizing or grinding to a preferred dimension of the chips aimed for the manufacturing processes of mechanical wood products. This chip fraction comprises in addition to butt logs considerable amounts of “normal wood”, i.e. wood usable in the manufacturing processes of mechanical wood products and is used as the material, following to the wood's subdivision into chips, preferably having an average length of from about 5 to about 20 mm and an average width of from about 3 to 10 mm. The particle reduced bark fraction comprises the dry cork fraction of the bark or powdered bark usable in the manufacturing processes of mechanical wood products.

Although it is possible to use the particle reduced chip fraction and dry cork fraction of the bark or powdered bark as such for extraction of polysaccharide substance and polysaccharide in combination with flavonoid substance, such as Dihydroquercetin (taxifolin), it may be preferable to first separate the material into a butt log fraction and bark fraction and to use these fractions for each fraction extraction. The “butt log fraction” means the “normal wood” that can be led to the process of obtaining mechanical wood products. The “dry cork fraction of the bark or powdered bark” means usable material in the manufacturing processes of mechanical wood products. This separation of fractions can be made directly from the material can first be refined before the subdividing into chips or powdered stage.

“Butt logs” and “bark” obtained as waste material or by-product of the logging process includes the cutting, skidding, on-site processing with utilization of the entire tree including bark, branches and tops. The utilized material can be further chipped or powdered and used for the production of clean electricity or heat.

The “polar solvent” is either a single polar agent, or a mixture of two or more polar agents, where said polar agent or agents have a dielectric constant that is greater than 3, determined at 25 Celsius degrees. As examples of polar solvents can be mentioned pure water only, and mixtures of water and alcohol, such as water and ethanol.

Dried wood or raw wood material can be used for extraction.

Although the extraction can be physically integrated with the utilization of wood in the manufacturing mechanical wood products, the extraction can alternatively be carried out as a separate process, because the butt logs and a bark, especially particle reduced chip fraction of butt logs and dry cork fraction of the bark or powdered bark, can easily be transported and stored for later processing.

The amount of polysaccharide and flavonoid substances in butt logs and bark varies greatly and depends on the each qualified wood material in question and the wood species used. Therefore, the extract derived from the extraction stage may contain considerable concentrations of polysaccharide and flavonoid substances, and may therefore, depending on the purpose, be used as such without further purification for obtaining crude polysaccharide and polysaccharide consisting with flavonoid yields.

In case further purification is needed, the methods to be used depend, inter alia, on the desired degree of purity of the substance. As examples of useful purification methods can be mentioned chromatography and\or crystallization.

As important polysaccharide substance to be isolated by the method of this invention can be mentioned Arabinogalactan, the class of long, densely branched low and high-molecular polysaccharides MW: 3,000-120,000 and Arabinogalactan consisting with flavonoid Dihydroquercetin (taxifolin), where is Arabinogalactan content, higher than 70% dry matter basis. Arabinogalactan consists of a main chain of b-D-(1fi3)-galactopyranose units (b-D-(1fi3)-Galp) where most of the main-chain units carry a side chain on C-6 [fi3,6)-Galp-(1fi]. Almost half of these side chains are b-D-(1fi6)-Galp dimers, and about a quarter are single Galp units. See FIG. 1. The rest contain three or more units. Arabinose is present both in the pyranose (Arap) and furanose (Araf) forms, attached to the side chains as arabinobiosyl groups [b-L-Arap-(1fi3)-LAraf-(1fi] or as terminal a-L-Araf e.g. a single L-arabinofuranose unit or 3-O-(β-L-arabinopyranosyl)-α-L-arabinofuranosyl units. Dihydroquercetin (taxifolin) is the flavonoid compound having molecule structure is based on C6-C3-C6 skeleton consisting of two aromatic rings joined by a three carbon link with the absence of the C2-C3 double bond and have two chiral carbon atoms in position 2 and 3. The A ring of the flavonoid structure being acetate derived (3×C2) and the C and B rings originating from cinnamic acid derivatives (phenylpropanoid pathway). Consequently, the B-ring can be either in the (2S)- or (2R)-configuration. The C-3 atom of dihydroflavonol Dihydroquercetin (taxifolin) bears both a hydrogen atom and a hydroxyl group, and is therefore an additional center of asymmetry. Thus, four stereoisomers are possible for each dihydroflavonol structure, (2R,3R), (2R,3S), (2S.3R), and (2S,3S). All four configurations have been found in naturally occurring dihydroflavonols, but the (2R,3R)-configuration is by far the most common.

The isolation of polysaccharide substance and polysaccharide substance in combination with flavonoid Dihydroquercetin (taxifolin) from butt logs and bark is very advantageous compared to the utilization of other sources. In these “butt log fraction” and “dry cork fraction of the bark or powdered bark”, the concentration of polysaccharide and flavonoid substances is 2 to 20 times higher than in normal wood. Many of these substances cannot be located at all in normal wood. As a result, about 70-80 % of the extract obtained according to this method may be the polysaccharide agent or agents, suggesting polysaccharide agent consisting with flavonoid agent. Another interesting feature is that a certain substances may be the dominating compound of the derived polysaccharide group of substances. For example, Arabinogalactan may be about 90-98% of the polysaccharides and Dihydroquercetin (taxifolin) may be about 75-85% of the flavonoids derived from larch wood butt logs.

This invention thus offers a unique method for deriving the desired polysaccharide substance or polysaccharide substance consisting with flavonoid Dihydroquercetin (taxifolin) in high concentrations in the extract. Along with this advantage, the wood material utilized for the extraction is material that hitherto has been regarded as a wood fraction useful as energy source only.

### Method of Isolation

For the purpose of illustration, the isolation of polysaccharide Arabinogalactan and polysaccharide Arabinogalactan in combination with flavonoid Dihydroquercetin (taxifolin) from wood of the Larch tree is described herein by way of example, however the methods can be readily be adapted for the isolation of compound from other fibrous plant materials such as other types of conifer trees. Prior to processing, the fibrous plant material, such as wood or bark, for example derived from a tree of the Larix genus, optionally may be sized to a preferred dimension using methods available in the art. In a typical system, the wood material butt logs and bark must be cut and ground or by a machine known in the art to comminute raw wood material into wood particles. The preferred size of the Larch wood particles depends upon the type of equipment used to process the wood particles. The raw wood particles are then fed to an inlet hopper for storage until the wood particles are required for the next step.

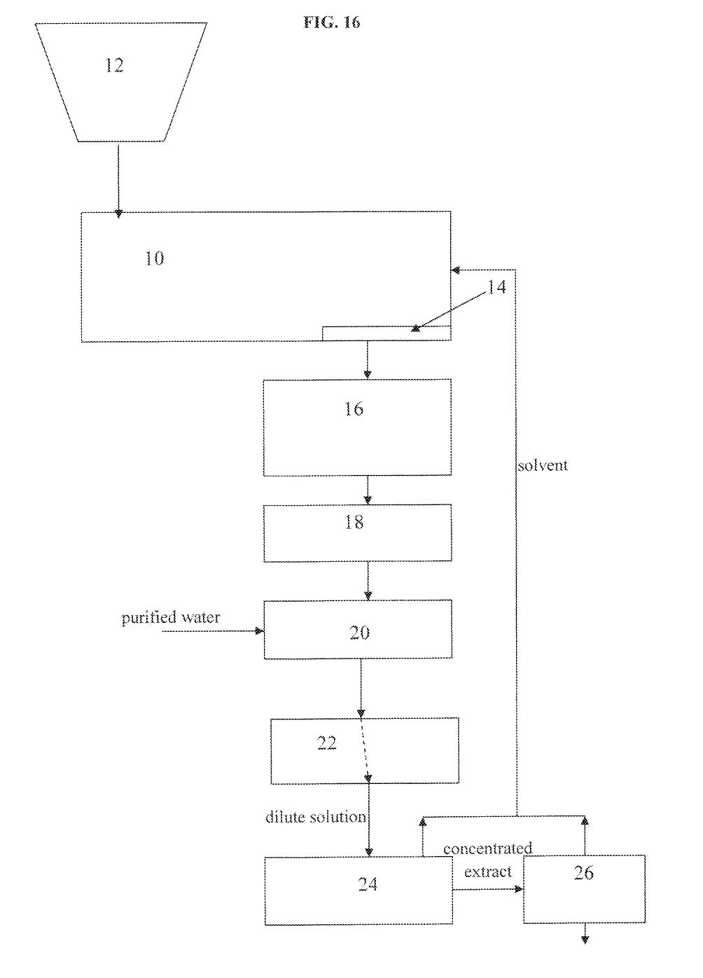

The properly sized and ground prepared wood particles are ready to be processed, they are transported from the inlet hopper via a chute 12 to an extractor unit 10. See FIG. 16. Extractor unit 10 is well known in the art, and typically includes an inlet and an outlet, level detectors for level control, and a solvent pretreatment inlet for optionally mixing prepared solvent mixture with the wood particles. The solvent mixture pretreatment is used to thaw or soften the wood particles so that the energy required to obtain exudate from the wood particles in later processing steps is decreased.

Method for deriving the desired polysaccharide substances or Arabinogalactan and Arabinogalactan in combination with Dihydroquercetin (taxifolin) prefers that the extraction is performed in vacuum system of using energy to heat the solvent mixture, a mixture of two or more polar agents in contact with wood particles, in order to extract polysaccharide substances from the wood particles. The extraction conditions including solid/liquid ratio, extraction time, extraction temperature and degree of vacuum can be optimized. Optimized conditions considered to be with solid/liquid ratio 1:2 up to 1:20, preferably 1:4, 1:6, and 1:12, extraction is performed at temperature of 38-40° C., and using water and/or water-ethanol mixture as the solvent agent.

The boiling point of the extraction solvent agent in vacuum is lower than that at normal air pressure. Thus, the extraction is performed at a lower temperature from 25° C. to maximum 40° C. It is good for preventing the degradation of thermo sensitive compound Dihydroquercetin (taxifolin). Also, the solvent agent can be kept boiling and refluxing at a lower temperature such as in the optimum range of 30° C.-38° C. It is good for mixing wood material with solvent agent and extracting compound out of wood material. Furthermore, the air in the extraction system is mostly pumped out, so the oxidation of the thermosensitive compound is avoided or reduced since there is little oxygen in the process of extraction.

The degree of vacuum and extraction temperature has obvious effect on the extraction yields of Arabinogalactan and Arabinogalactan with flavonoid Dihydroquercetin (taxifolin). The degree of vacuum can be adjusted following the extraction at a temperature of 30-38° C., which causes the solvent agent to have a higher capacity at such temperatures, and enough to cause the solvent refluxing continuously. Moreover, the mixing of solvent and wood particles at pre-extraction stage leads to the higher extraction yields of the polysaccharide substances.

The principle of solid-liquid extraction in a vacuum system is that when a solid material comes in contact with a solvent agent, the soluble in mixture components in the solid wood particles such as Arabinogalactan and Arabinogalactan with flavonoid Dihydroquercetin (taxifolin) move into the solvent agent. Thus, solvent extraction under vacuum of wood material results in a mass transfer of soluble active principles to the solvent agent, and this takes place in a concentration gradient. Since mass transfer of the active principles Arabinogalactan and Arabinogalactan with flavonoid Dihydroquercetin (taxifolin) also depends on their solubility in the solvent agent, heating the solvent mixture can enhances the mass transfer.

For extraction, the solvent or solvent agent is chosen as a function of the type of Arabinogalactan and Arabinogalactan with flavonoid Dihydroquercetin (taxifolin) required. Polarity is an important consideration here. More polar flavonoid Dihydroquercetin (taxifolin) is extracted with ethanol or ethanol-water mixtures and water soluble Arabinogalactan is extracted mainly by water and water-ethanol mixtures. The bulk of extractions of polysaccharide—containing material are performed by simple direct solvent extraction in a vacuum system.

The solvent exudate or extract obtained as a result of the above process, often contains cellulosic particles. Consequently, a screening step is necessary. The extract so obtained is separated out from the marc (exhausted wood material) by allowing it to trickle into a holding tank 16 through the built-in false bottom of the extractor, which is covered with a screening facilities 14 of the art. The marc is retained at the false bottom, and the extract is received in the holding tank 16. From the holding tank, the extract is pumped into a sparkler filter 18 to remove cellulosic particles from the extract. Screened extract is then sent to an extract storage tank 20 where purified water is added. The extract is then further heated under vacuum before being sent through a pall separator 22. The permeate from this separation contains 10-12% arabinogalactan by weight. This dilute solution is then sent to the vacuum evaporator 24. The state of art is cautious vacuum evaporation, in which evaporation temperatures do not exceed 45° C. The temperature in relation to the evaporation time is of special importance for quality of this step, especially if the extract contains thermolabile constituents like flavonoid Dihydroquercetin (taxifolin).

The concentrated-extract is further fed into a vacuum chamber dryer 26 to produce a solid paste mass free from solvent. The solvent recovered from the vacuum evaporator 24 and vacuum chamber dryer 26 is recycled back to the extractor for the next batch of wood material. The extract of the evaporator contains 50-60% of arabinogalactan substance. The concentrated extract thus obtained is used directly for the further processed for isolation of Arabinogalactan and/or Arabinogalactan consisting with flavonoid Dihydroquercetin (taxifolin).

Optionally, this concentrated extract can be sent through an ion exchange step further purify the liquid before it is spray-dried or freeze dried, or it can be decolorized, and further processed to reduce color, odor, and flavor. The decolorization is accomplished by treating the product with specified quantities of 40-45% potassium hydroxide and 30-35% hydrogen peroxide solutions alternatively; various concentrations of calcium hydroxide may be substituted for potassium hydroxide. After decolorization, the product is then cooled via cooling water. Following cooling, the concentration of the bulk arabinogalactan substance in solution is 40-45%. This product may enter one of several streams following decolorization and cooling: 1) it may be directly spray or freeze agglomerated; 2) it may be sent through a carbon filter followed by spray or freeze agglomeration; 3) it may be sent through a carbon filter and an ion exchange step prior to being spray or freeze agglomerated; or 4) it may go directly through an ion exchange step, a spray or freeze drying step and then be agglomerated.

Spray Drying: The filtered extract is subjected to spray drying with a high pressure pump at a controlled feed rate and temperature, to get dry powder. The desired particle size of the product is obtained by controlling the inside temperature of the chamber and by varying the pressure of the pump.

The aqueous concentrated extract can be also concentrated in two stages, preferably by freezing, using Gulf crystallizers, for example. After the first stage, the extract is in the form of a pumpable slurry which is centrifuged to provide a concentrated liquor containing about 40% total solids, which is further concentrated to about 50% total solids in the second stage. The arabinogalactan extract is then frozen as described below. The frozen product is broken up and ground to a particle size of 0.1 to 0.2 mm. After freeze-drying, the powder is agglomerated in a suitable agglomeration chamber. The agglomerated powder, having a density up to 0.7 g/cm³, may be packed an air-tight containers in an inert atmosphere.

Drying of the concentrated arabinogalactan extract should preferably be carried out under controlled conditions such that the finished product possesses an appropriate density and color. Extract is frozen to a solid mass, for example on a cooled metal belt on which it is preferably spread at a layer thickness of 10 to 40 mm. Preferably, cooling is effected in two stages, for example on a belt which comprises two sections which are at different temperatures. Thus, the first section of the belt may be cooled to a temperature of −12° C. to −29° C., whilst the second section may be at a lower temperature, for example between −40° C. and −70° C. In general, it is preferred for the entire cooling belt stage to be not less than about 7 minutes, and may be as long as 25 minutes.

At the end of the belt the extract is removed as a continuous rigid sheet which may then be broken up into fragments suitable for grinding. These fragments may, for example, be ground to a particle size which is preferably within the range. The ground particles are then freeze-dried in conventional cabinets, on trays which are loaded to a layer thickness of, for example, 25 mm. The sublimation of the ice crystals is effected under a high vacuum, of about 150 to 175 microns, and generally lasts around 7 hours. Thereafter, the product may be packed as desired. In a modification of the process, the frozen extract may be freeze-dried in the form of plates or lumps which are subsequently ground to the desired particle size <100 μm. This method enables to produce an increased quantity of very fine particles. A dry powder is obtained having the appearance of fine powder particles <100 μm of white to light beige color and a density of 0.3-0.7 g/cm3.

In the preceding specification, the invention has been described with reference to specific exemplary embodiments thereof. It will however, be evident that various modifications and changes may be made thereto without departing from the broader spirit and scope of the invention as set forth in the claims that follow. The specification and drawings are accordingly to be regarded in an illustrative manner rather than a restrictive sense.

1. A method for simultaneously isolating an arabinogalactan compound and a second compound including arabinogalactan and flavonoid dihydroquercetin (taxifolin) from wood, said method comprising the steps of:
a) fanning a particle-reduced chip fraction by subdividing said wood into chips having an average length of 5 mm to 20 mm. and a width of 3 mm to 10 mm;
b) combining the particle-reduced chip fraction with a polar solvent solution comprising pure water and ethanol;
c) vacuum extracting an extract from the combination of the polar solvent with the particle-reduced chip fraction, the step of vacuum extracting being performed in a vacuum system by heating said combination to a temperature of 25° C. to 40° C.; and
c) recovering said extract obtained as a result of said step of extracting, said recovered extract including a first compound comprising an arabinogalactan and a second compound comprising a combination of the arabinogalactan and a dihydroquercetin, a content of said arabinogalactan being at least 70% of a weight of the first compound on dry matter basis and a content of said dihydroquercetin being in a range of 5% to 50% of a weight of the second compound on dry matter basis,
wherein the wood is a coniferous hardwood or a coniferous wood selected from the group consisting of a wood of a Larix genus, a spruce wood of a genus Picea, a fir wood of a genus Abies, a pine wood of a genus Pinus, or a wood of a Pseudotsuga genus.

2. The method of claim 1, wherein said content of said dihydroquercetin (taxifolin) is in a range of 5%-10% of the weight of the second compound.

3. The method of claim 1, wherein said content of said dihydroquercetin (taxifolin) is in a range of 10%-15% of the weight of the second compound.

4. The method of claim 1, wherein said content of said dihydroquercetin (taxifolin) is in a range of 15%-20% of the weight of the second compound.

5-7. (canceled)

8. The method of claim 1, wherein said steps of vacuum extracting and recovering further comprise a step of continuous thermo vacuum extraction.

9. The method of claim 1, wherein the hardwood comprises a wood or a bark of a plant of the Larix genus.

10. The method of claim 1, wherein the extract obtained in said step of vacuum extracting is contacted with a freshest plant material in a presoak mixing volume.

11. (canceled)

12. The method of claim 1, further comprising a step of freeze drying a recovered extract.

13. The method according to claim 1, wherein the hardwood is larch.
